(19) United States
(12) Patent Application Publication
(10) Pub. No.: US 2011/0131207 A1
(43) Pub. Date: Jun. 2, 2011

(54) TEXT MESSAGING HOT TOPICS

(75) Inventor: Hakan Lars Emanuel Jonsson, Hjarup (SE)

(73) Assignee: SONY ERICSSON MOBILE COMMUNICATIONS AB, Lund (SE)

(21) Appl. No.: 12/628,338

(22) Filed: Dec. 1, 2009

(51) Int. Cl. G06F 17/30

(52) U.S. Cl. 707/730; 707/776; 707/722; 707/E17.016

(57) ABSTRACT

A device includes a memory to store instructions; and a processor to execute the instructions to implement a data collector to collect text messages, a keyword extractor to extract keywords or key phrases from the collected text messages, and a user interface to present one or more of the extracted keywords or key phrases to a particular user. The device further includes a filter to filter the collected text messages based on one or more criteria, and a keyword ranker to rank the extracted keywords or key phrases based on one or more criteria.

### BACKGROUND

Mobile electronic devices, such as cell phones, may provide multiple ways in which users can communicate. For example, users may be able to place and receive telephone calls, exchange email messages, and/or receive audio or video streams. One function that may be implemented by mobile communication devices may be text messaging, also known as short message service (SMS). Text messaging may allow a user to send a short text message (typically up to 160 characters) to another user using standard telephony service, such as a Global System for Mobile Communication (GSM) system. As a result of the ease, convenience, and cost-effectiveness of text messaging, text messaging has become a very popular form of communication, and vast numbers of text messages are sent and received by users every day.

### SUMMARY

According to one aspect, a device may include a memory to store instructions; and a processor to execute the instructions to implement a data collector to collect text messages; a keyword extractor to extract keywords or key phrases from the collected text messages; and a user interface to present one or more of the extracted keywords or key phrases to a particular user.

Additionally, the data collector may collect text messages from call detail records or from user devices.

Additionally, the device may include a filter to filter the collected text messages based on one or more criteria.

Additionally, the one or more criteria may include a location associated with a particular text message, a time and date when the particular text message was sent, a language associated with the particular text message, an age of a sender of the particular text message, or whether the particular text message includes profanity, abusive language, or sexually explicit language.

Additionally, the keyword extractor may be to at least one of recognize terms particular to text messages; eliminate stop words from consideration as a keyword or a key phrase; correct for spelling errors in the extracted keywords or key phrases; or perform stemming on the extracted keywords or key phrases.

Additionally, the device may include a keyword ranker to rank the extracted keywords or key phrases based on one or more criteria.

Additionally, the one or more criteria may include a frequency associated with a particular keyword or key phrase; a geographic proximity of instances of the particular keyword or key phrase; a number of recipients associated with instances of the particular keyword or key phrase; or the particular user's preferences.

Additionally, the keyword ranker may be to rank the extracted keyword or key phrases based on at least two different ranking scales.

Additionally, the user interface may include a tag cloud of the presented keywords or key phrases; a menu list of the presented keywords or key phrases; or a movable sphere with the presented keywords or key phrases printed on a surface of the sphere.

Additionally, the user interface may include an option to receive a request, associated with a particular one of the presented keywords or key phrases, for additional information, and the user interface may be to provide the additional information in response to receiving the request.

Additionally, the request may include at least one of a request to view text messages associated with the particular one of the presented keywords or key phrases; a request to view other keywords associated with the particular one of the presented keywords or key phrases; or a request to perform a search based on the particular one of the presented keywords or key phrases.

According to another aspect, a method performed by a server device may include collecting, using a processor associated with the server device, text messages sent within a particular geographic area within a particular time period; extracting, using a processor associated with the server device, keywords or key phrases from the collected text messages; and providing, using a communication interface associated with the server device, one or more of the extracted keywords or key phrases to a particular user.

Additionally, the method may include filtering the collected text messages based on one or more criteria.

Additionally, the one or more criteria may include a location associated with a particular text message, a time and date when the particular text message was sent, a language associated with the particular text message, an age of a sender of the particular text message, or whether the particular text message includes profanity, abusive language, or sexually explicit language.

Additionally, extracting keywords or key phrases may include recognizing terms particular to text messages; eliminating stop words from consideration as a keyword or a key phrase; correcting for spelling errors in the extracted keywords or key phrases; or performing stemming on the extracted keywords or key phrases.

Additionally, the method may include ranking the extracted keywords or key phrases based on one or more criteria.

Additionally, the one or more criteria may include a frequency associated with a particular keyword or key phrase; a geographic proximity of instances of the particular keyword or key phrase; a number of recipients associated instances of the particular keyword or key phrase; or the particular user's preferences.

Additionally, providing the one or more of the extracted keywords or key phrases may include providing the one or more of the extracted keywords of key phrases in one of a tag cloud of the one or more extracted keywords or key phrases; a menu list of the one or more extracted keywords or key phrases; or a movable sphere with the one or more extracted keywords or key phrases printed on a surface of the sphere.

Additionally, the method may include receiving a request for additional information associated with one of the one or more provided keywords or key phrases, and providing the additional information in response to receiving the request.

According to yet another aspect, one or more memory devices, storing instructions executable by one or more processors, may include one or more instructions to collect text messages sent within a particular geographic area within a particular time period; one or more instructions to filter the collected text messages based on one or more criteria associated with the filtered collection of text messages; one or more instructions to extract keywords or key phrases from the collected text messages; one or more instructions to rank the extracted keywords or key phrases based on frequency of occurrence; and one or more instructions to provide one or more of the extracted keywords or key phrases to a particular user in a user interface.

### BRIEF DESCRIPTION OF THE DRAWINGS

The accompanying drawings, which are incorporated in and constitute a part of this specification, illustrate one or more systems and/or methods described herein and, together with the description, explain these systems and/or methods. In the drawings:

FIG. 1 is an overview of an exemplary system in which systems and methods described herein may be implemented;

FIG. 2 is a diagram of an exemplary user device in which systems and/or methods described herein may be implemented;

FIG. 3 is a diagram illustrating exemplary components of the user device of FIG. 2;

FIG. 4 is a diagram illustrating exemplary components of a text messaging hot topics system of FIG. 1;

FIG. 5 is a diagram of exemplary functional components of the text messaging hot topics system of FIG. 1;

FIG. 6 is a flow graph of an exemplary process of providing text messaging keywords to a user according to an implementation described herein;

FIG. 7 is a flow graph of an exemplary process of receiving selections from a user according to an implementation described herein;

FIG. 8A is a diagram illustrating a first exemplary user interface according to an implementation described herein;

FIG. 8B is a diagram illustrating another aspect of the first exemplary user interface of FIG. 8A;

FIG. 9 is a diagram illustrating a second exemplary user interface according to an implementation described herein;

FIG. 10A is a diagram illustrating a third exemplary user interface according to an implementation described herein; and

FIG. 10B is a diagram illustrating another aspect of the third exemplary user interface of FIG. 10A.

### DETAILED DESCRIPTION

The following detailed description refers to the accompanying drawings. The same reference numbers in different drawings identify the same or similar elements. Also, the following detailed description does not limit the invention.

Exemplary implementations described herein may relate to providing, to a particular user, hot topics that other users are texting about in a particular geographic area. Hot topics, which may also be referred to as hot trends, may refer to topics that are being currently discussed in text messages in the particular geographic area. When a user receives indications of the hot topics in the user's vicinity, the user may be able to learn important information. For example, the user may find out about an accident, traffic conditions, a particular location towards which many other users are heading (e.g., a sports stadium), or a popular venue (e.g., a nightclub). Additionally, a user may also experience a feeling of being connected to other people in the area by knowing about topics that other users are discussing via text messaging. Indications of hot topics in the particular user's vicinity may be provided in the form of keywords or key phrases extracted from text messages sent by other users in the vicinity. A key phrase may include one or more keywords.

Implementations described herein may relate to collecting text messages of users without violating privacy of the users, extracting keywords or key phrases from the collected text messages, and providing the extracted keywords or key phrases to a particular user's mobile communication device (e.g., on a display screen of a cell phone). In one implementation, text messages may be collected from call detail records by a server. In another implementation, text messages may be collected from mobile communication devices of users and uploaded to a database. Collected messages may be filtered based on one or more criteria, such as whether a user has given permission for having the user's messages collected, or based on a geographic area.

Keyword extraction algorithms may be applied to the collected messages and a list of keywords and/or key phrases may be accumulated. The collected keywords or key phrases may be ranked based on one or more criteria. The ranking may be independent of a particular user or may be based on a particular user. An example of a ranking factor independent of a user may include the number of instances of a keyword (i.e., the frequency of occurrence of a keyword or key phrase). An example of a ranking factor that depends on a particular user may include a user's interest. The ranked keywords may be provided for display on a particular user's user device. The ranked keywords may be displayed using a format selected from one or more available formats. Available formats may include, for example, a tag cloud, a widget such as a menu list or a button with a tooltip, an animation such as a ticker tape, and/or other formats. Alternatively, a user may select to receive keywords or key phrases via text messages.

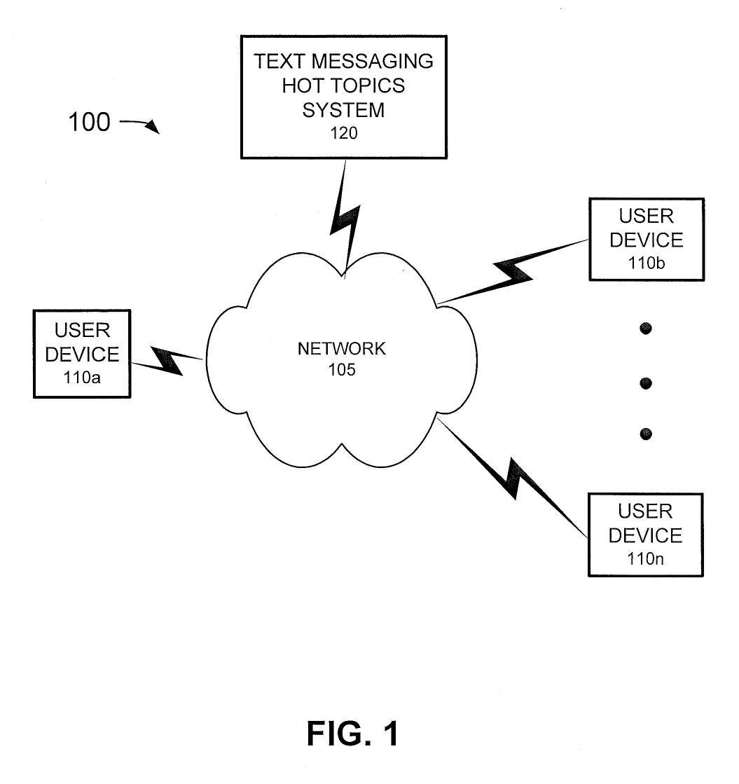

FIG. 1 is an overview of an exemplary system 100 in which systems and methods described herein may be implemented. System 100 may include a network 105, user devices 110a-110n, and a text messaging hot topics system 120.

Network 105 may include a circuit-switched network or a packet-switched network. For example, network 105 may include one or more of a local area network (LAN), a wide area network (WAN), a metropolitan area network (MAN), a wireless network, such as a general packet radio service (GPRS) network, an ad hoc network, a public switched telephone network (PSTN), a subset of the Internet, any other network, or any combination thereof.

User devices 110a-110n may include any portable electronic device with communication capabilities. For example, user device 110 may include a cellular radiotelephone with or without a multi-line display; a personal communications system (PCS) terminal that may combine a cellular radiotelephone with data processing, facsimile, and data communications capabilities; a PDA that may include a radiotelephone, pager, Internet/Intranet access, Web browser, organizer, calendar, and/or a global positioning system (GPS) receiver; a laptop and/or palmtop receiver; or other appliances that include a radiotelephone transceiver. User device 110 may also include media playing capability. User device 110 may connect to network 105 via a wired or a wireless connection.

Text messaging hot topics system 120 may include one or more devices that collect text messages sent and received by users connected to network 105 via user devices 110a-110n. Text messaging hot topics system 120 may filter the collected messages based on one or more criteria, extract keywords from the filtered messages, rank the extracted keywords based on one or more criteria, and provide the ranked keywords to a user of user device 110a (e.g., via a display of user device 110a.

Text messages collected by text messaging hot topics system 120 need not be sent by user device 110. For example, providers of mobile communication services may provide an option to subscribers to send text messages from devices other than user device 110 which is registered with the provider. For example, users may log into a website associated with the provider and send messages via the website. Similarly, a user may receive keywords on a device other than user device 110. For example, a user may receive keywords on a desktop computer.

Although FIG. 1 shows exemplary devices of system 100, in other embodiments, network system 100 may include fewer, different, or additional devices than depicted in FIG. 1. Additionally or alternatively, one or more devices of system 100 may perform the tasks described as being performed by one or more other devices of system 100.

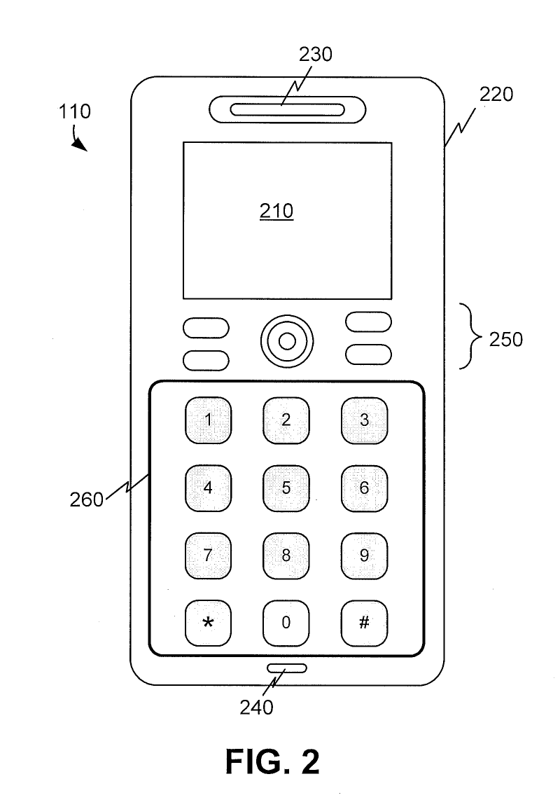

FIG. 2 is a diagram of an exemplary user device 110 in which systems and/or methods described herein may be implemented. As shown, user device 110 may include a display 210, a housing 220, a speaker 230, a microphone 240, control buttons 250, and a keypad 260.

Display 210 may provide visual information to the user. Display 210 may be a color display, such as a red, green, blue (RGB) display, a monochrome display or another type of display. Display 210 may include a touch sensor display that may be configured to receive a user input when the user touches display 210. For example, the user may provide an input to display 210 directly, such as via the user's finger, or via other input objects, such as a stylus. User inputs received via display 210 may be processed by components and/or devices operating in user device 110. The touch screen may permit the user to interact with user device 110 in order to cause user device 110 to perform one or more operations. In one exemplary implementation, display 210 may include a liquid crystal display (LCD) display. Display 210 may include a driver chip (not shown) to drive the operation of display 210.

Housing 220 may protect the components of user device 100 from outside elements. Housing 220 may include a structure configured to hold devices and components used in user device 100, and may be formed from a variety of materials. For example, housing 220 may be formed from plastic, metal, or a composite, and may be configured to support display 210, speaker 230, microphone 240, control buttons 250, and keypad 260.

Speaker 230 may provide audible information to a user of user device 100. Speaker 230 may be located in an upper portion of user device 110, and may function as an ear piece when a user is engaged in a communication session using user device 110. Speaker 230 may also function as an output device for music and/or audio information associated with games, voicemails, and/or video images played on user device 110.

Microphone 240 may receive audible information from the user. Microphone 240 may include a device that converts speech or other acoustic signals into electrical signals for use by user device 110. Microphone 240 may be located proximate to a lower side of user device 110.

Control buttons 250 may permit the user to interact with user device 110 to cause user device 110 to perform one or more operations, such as place a telephone call, play various media, etc. For example, control buttons 250 may include a dial button, a hang up button, a play button, etc. Keypad 260 may include a telephone keypad used to input information into user device 110.

In an exemplary implementation, functionality of control buttons 250 and/or keypad 260 may be implemented via display 210, and control buttons 250 and keypad 260 may not be present in user device 100. In another implementation, control buttons 250 and keypad 260 may be present and different control buttons and keypad elements may be implemented via display 210 based on the particular mode in which user device 110 is operating. For example, when operating in a cell phone mode, functions associated with control buttons 250 and keypad 260 may be implemented using display 210, instead of, or in addition to, the functions being implemented using control buttons 250 and keypad 260. For example, a telephone keypad and control buttons associated with dialing, hanging up, etc., may be displayed via display 210. In other modes, functions associated with control buttons 250 and/or keypad 260 may not be implemented using display 210.

Although FIG. 2 shows exemplary components of user device 110, in other implementations, user device 110 may contain fewer, different, additional, or differently arranged components than depicted in FIG. 2. Additionally or alternatively, one or more components of user device 110 may perform one or more other tasks described as being performed by one or more other components of user device 110.

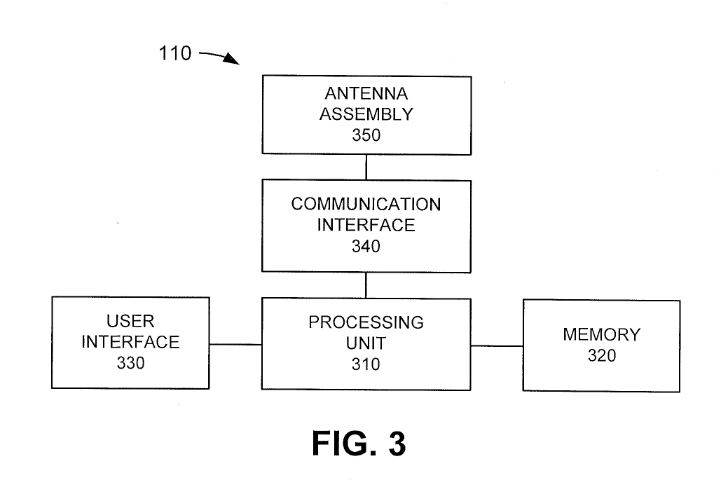

FIG. 3 illustrates a diagram of exemplary components of user device 110. As shown in FIG. 3, user device 110 may include a processing unit 310, a memory 320, a user interface 330, a communication interface 340, and an antenna assembly 350.

Processing unit 310 may include one or more processors, microprocessors, application specific integrated circuits (ASICs), field programmable gate arrays (FPGAs), or the like. Processing unit 310 may control operation of user device 100 and its components.

Memory 320 may include a random access memory (RAM), a read only memory (ROM), and/or another type of memory to store data and instructions that may be used by processing unit 310.

User interface 330 may include mechanisms for inputting information to user device 110 and/or for outputting information from user device 100. Examples of input and output mechanisms might include a speaker (e.g., speaker 230) to receive electrical signals and output audio signals; a camera lens to receive image and/or video signals and output electrical signals; a microphone (e.g., microphone 240) to receive audio signals and output electrical signals; buttons (e.g., a joystick, control buttons 250, or keys of keypad 260) to permit data and control commands to be input into user device 110; a display (e.g., display 210) to output visual information; and/or a vibrator to cause user device 110 to vibrate.

Communication interface 340 may include any transceiver-like mechanism that enables user device 110 to communicate with other devices and/or systems. For example, communication interface 340 may include a modem or an Ethernet interface to a local area network (LAN). Communication interface 340 may also include mechanisms for communicating via a network, such as a wireless network. For example, communication interface 340 may include, for example, a transmitter that may convert baseband signals from processing unit 310 to radio frequency (RF) signals and/or a receiver that may convert RF signals to baseband signals. Alternatively, communication interface 340 may include a transceiver to perform functions of both a transmitter and a receiver. Communication interface 240 may connect to antenna assembly 350 for transmission and/or reception of the RF signals.

Antenna assembly 350 may include one or more antennas to transmit and/or receive RF signals over the air. Antenna assembly 350 may, for example, receive RF signals from communication interface 340 and transmit them over the air and receive RF signals over the air and provide them to communication interface 340. In one implementation, for example, communication interface 340 may communicate with a network, such as network 105.

As described herein, user device 110 may perform certain operations in response to processing unit 310 executing software instructions contained in an article of manufacture that includes a computer-readable medium, such as memory 320. A computer-readable medium may be defined as a physical or logical memory device. A logical memory device may include memory space within a single physical memory device or spread across multiple physical memory devices. The software instructions may be read into memory 320 from another computer-readable medium or from another device via communication interface 340. The software instructions contained in memory 320 may cause processing unit 310 to perform processes that will be described later. Alternatively, hardwired circuitry may be used in place of or in combination with software instructions to implement processes described herein. Thus, implementations described herein are not limited to any specific combination of hardware circuitry and software.

Although FIG. 3 shows exemplary components of user device 110, in other implementations, user device 110 may contain fewer, different, additional, or differently arranged components than depicted in FIG. 3. Additionally or alternatively, one or more components of user device 110 may perform one or more other tasks described as being performed by one or more other components of user device 110.

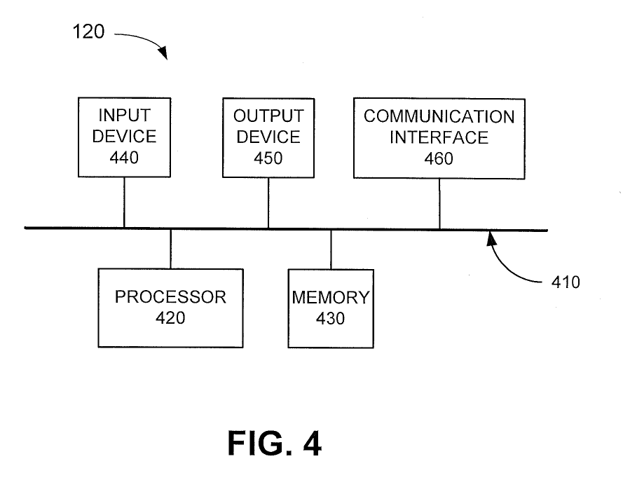

FIG. 4 is a diagram illustrating exemplary components of text messaging hot topics system 120. As illustrated, text messaging hot topics system 120 may include a bus 410, a processor 420, a memory 430, an input device 440, an output device 450, and/or a communication interface 460.

Bus 410 may include a path that permits communication among the components of text messaging hot topics system 120.

Processor 420 may include one or more processors, microprocessors, ASICs, FPGAs, or other types of processors that may interpret and execute instructions, programs, or data structures. Processor 420 may control operation of text messaging hot topics system 120 and its components.

Memory 430 may include a RAM or another type of dynamic storage device that may store information and/or instructions for execution by processor 420; a ROM or another type of static storage device that may store static information and/or instructions for use by processor 420; a flash memory (e.g., an electrically erasable programmable read only memory (EEPROM)) device for storing information and/or instructions; and/or some other type of magnetic or optical recording medium and its corresponding drive. Memory 430 may also be used to store temporary variables or other intermediate information during execution of instructions by processor 420. Instructions used by processor 420 may also, or alternatively, be stored in another type of computer-readable medium accessible by processor 420.

Input device 440 may include a mechanism that permits an operator to input information to text messaging hot topics system 120, such as a keyboard, a mouse, a pen, a microphone, voice recognition and/or biometric mechanisms, a touch screen, etc. Output device 450 may include a mechanism that outputs information to the operator, including a display, a printer, a speaker, etc.

Communication interface 460 may include any transceiver-like mechanism that enables text messaging hot topics system 120 to communicate with other devices and/or systems. For example, communication interface 460 may include a modem or an Ethernet interface to a LAN. Communication interface 460 may also include mechanisms for communicating via a network, such as a wireless network. For example, communication interface 460 may include, for example, a transmitter that may convert baseband signals from processor 420 to RF signals and/or a receiver that may convert RF signals to baseband signals. Alternatively, communication interface 460 may include a transceiver to perform functions of both a transmitter and a receiver.

As described herein, text messaging hot topics system 120 may perform certain operations in response to processor 420 executing software instructions contained in a computer-readable medium, such as memory 430. The software instructions may be read into memory 430 from another computer-readable medium, such as a magnetic or optical recording medium and its corresponding drive, or from another device via communication interface 460. The software instructions contained in memory 430 may cause processor 420 to perform processes described herein. Alternatively, hardwired circuitry may be used in place of or in combination with software instructions to implement processes described herein. Thus, implementations described herein are not limited to any specific combination of hardware circuitry and software.

Although FIG. 4 shows exemplary components of text messaging hot topics system 120, in other implementations, text messaging hot topics system 120 may contain fewer, different, differently arranged, or additional components than depicted in FIG. 4. Additionally or alternatively, one or more components of text messaging hot topics system 120 may perform one or more other tasks described as being performed by one or more other components of text messaging hot topics system 120.

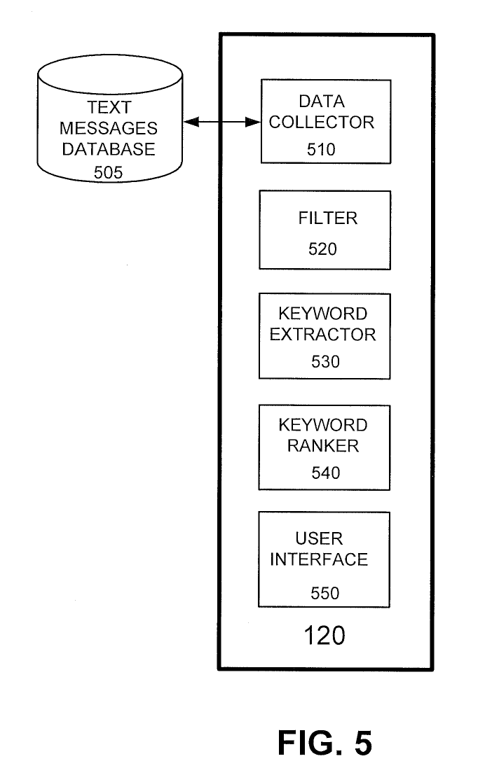

FIG. 5 is a diagram of exemplary functional components of text messaging hot topics system 120. Text messaging hot topics system 120 may include a text messages database 505, a data collector 510, a filter 520, a keyword extractor 530, a keyword ranker 540, and a user interface 550.

Text messages database 505 may store text messages collected by data collector 510. Text messages database 505 may be implemented by text messaging hot topics system 120 or by another computer system that is in communication with text messaging hot topics system 120.

Data collector 510 may collect text messages sent by users communicating via network 105. Data collector 510 may collect text messages from call detail records stored at a server associated with network 105 and periodically transferred to text messages database 505. Additionally or alternatively, text messages may be collected from user devices 110a-110n. At configurable intervals, text messages from user devices 110a-110n may be collected, compressed, and uploaded to text messages database 505 through data collector 510.

Filter 520 may filter collected messages based on one or more criteria. In an exemplary implementation, filter 520 may filter collected messages based on a geographic location associated with the collected messages. In one implementation, the geographic location may be determined based on network-based techniques, device-based techniques, or a combination of the two. An example of a network-based technique may include using Global System for Mobile Communications (GMS) localization or using a cellular ID associated with a text message. An example of a device-based technique may include obtaining information from a Global Positioning Satellite (GPS) receiver included in user device 110.

In other implementations, filter 520 may use additional, or different criteria. For example, filter 520 may filter text messages based on recency and remove from consideration text messages that are older than a particular length of time (e.g., one day). As another example, filter 520 may filter messages to remove messages that include profanity, abusive or threatening language, or sexually explicit language. As yet another example, filter 520 may also filter messages based on a language of a text message, or based on an age of the sender of a message. Filter 520 may be able to determine a sender's age from the sender's user profile, if the sender gives permission to reveal the sender's personal information to text messaging hot topics system 120.

Keyword extractor 530 may extract keywords or key phrases from the filtered text messages. A key phrase may include one or more keywords and may be limited to a particular number of keywords, such as three keywords. Keyword extractor 530 may employ any existing keyword extraction algorithm. For example, keyword extractor 530 may use a lexicon of keywords to recognize keywords in text message. The lexicon may be tailored towards text messaging, and may thus include abbreviations and jargon associated with text messages. Keyword extractor 530 may use statistical techniques to extract keywords. Keyword extractor 530 may also be trained using a training set of text messages to recognize keywords. Keyword extractor 530 may additionally consult a lexicon of common or frequent words of a language to filter out words that may be considered stop words. Examples of such words may include “and,” “or,” “I,” “you,” etc.

Keyword ranker 540 may rank the extracted keywords based on one or more criteria. In an exemplary implementation, keyword ranker 540 may rank the extracted keywords based on frequency of occurrence. Thus, keywords that appeared in more text messages may be ranked higher than keywords occurring less frequently. Alternatively, keyword ranker 540 may rank the extracted keywords based on a combination of frequency of occurrence during a particular time period and an inverse keyword frequency of keywords in a collection of text messages. Keywords that appear less frequently in a collection may have a higher inverse keyword frequency and may be more important.

In other implementations, keyword ranker 540 may rank keywords based on additional or different criteria. For example, keyword ranker 540 may rank keywords or key phrases based on a number of terms. A key phrase with more terms may be more important than a keyword that only includes one word. As another example, keyword ranker 540 may rank keywords or key phrases based on geographic factors, such as how many text messages are sent from a particular location. Multiple text messages sent from a same location may be more important than if the text messages were sent from different locations. As yet another example, keyword ranker 540 may rank keyword or key phrases based on a number of recipients. Senders may send text messages to more than one recipient, and text messages sent to multiple recipients may be more important. Keyword ranker 540 may also rank keywords or key phrases based on factors associated with a particular user that is to receive the ranked keywords or key phrases. Factors associated with a particular user may include topics or interests associated with the particular user, or the identity of the senders of the text messages. Senders of text messages may give permission to have their identity revealed, and a particular user may want to see keywords or key phrases from text messages sent by other users that the particular user knows.

User interface 550 may provide the ranked keywords to user device 110. For example, in one implementation, user interface 550 may transmit the ranked keywords in a format recognizable by a hot topics application, associated with text messaging hot topics system 120, which has been installed on user device 110. In other implementations, user interface 550 may provide a graphical interface to user device 110 without the need to install a hot topics application to user device 110.

Although FIG. 5 shows exemplary functional components of text messaging hot topics system 120, in other implementations, text messaging hot topics system 120 may contain fewer, different, differently arranged, or additional functional components than depicted in FIG. 5. Additionally or alternatively, one or more functional components of text messaging hot topics system 120 may perform one or more other tasks described as being performed by one or more other functional components of text messaging hot topics system 120.

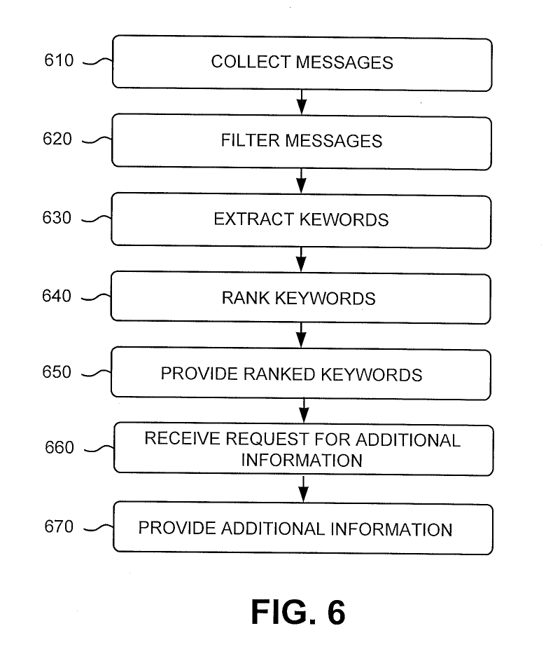

FIG. 6 is a flow graph of an exemplary process of providing text messaging keywords to a user according to an implementation described herein. In one implementation, the process of FIG. 6 may be performed by text messaging hot topics system 120. In other implementations, the process of FIG. 6 may be performed by a different device or a group of devices.

The process of FIG. 6 may include collecting messages (block 610). For example, data collector 510 may collect text messages that are sent and/or received by users communicating via network 105. The text messages that are collected need not have been sent by users in network 105. For example, a user device 110 may receive a text message from a device located on another network and the text message may be collected by data collector 510.

Text messages may be collected from call detail records stored at a server associated with network 105 and periodically transferred to text messages database 505. A call detail record (CDR) may store information that includes a calling number; a receiving number; a route of the call, which may include a base station, home register, and/or visiting register associated with the calling number, and a base station, home register, and/or visiting register associated with the receiving number; a date and time of the call; a duration of the call; and, if the call includes a text message, the contents of the text message.

Additionally or alternatively, text messages may be collected from user devices 110a-110n. For example, at configurable intervals, text messages from user devices 110a-110n may be collected, compressed, and uploaded to text messages database 505.

In order to protect users' privacy, a particular user may be asked for permission before the particular user's text messages are collected. Alternatively or additionally, only the content of a text message, along with location information (e.g., a cell identification number), may be collected. Thus, any data that identifies a particular user, such as a Mobile Station Integrated Services Digital Network Number (MSISDN) or International Mobile Subscriber Identity (IMSI), may not be recorded. Text messages collected from a CDR may be similarly anonymized.

The collected messages may be filtered (block 620). For example, filter 520 may filter the collected messages based on one or more criteria. Text messages may be filtered based on whether a user has given permission to have keywords or key phrases extracted from the user's text messages. Some users may not want to provide keywords or key phrases, even when such keywords or key phrases are anonymized. Filter 520 may remove such text messages from consideration for keyword extraction.

In one implementation, the one or more criteria may include the location associated with particular text messages. For example, filter 520 may only select messages for a particular geographic area, such as a cellular identification number, a neighborhood, or a city. In one implementation, the size of the geographic area may be determined by text messaging hot topics system 120. In another implementation, a user may be able to configure the size of the geographic area.

In one implementation, text messages may be filtered based on the location of the sender of a text messages. In another implementation, text messages may be filtered based on the location of the recipient of a text message. In yet another implementation, text messages may be filtered based on the location of both the sender and the recipient of a text message. For example, text messages may be filtered for text messages that are both sent and received by users in the same geographic area (e.g., messages sent and received within a city, or a neighborhood of a city).

Additionally or alternatively, other filtering criteria may be used. If other filtering criteria are used, additional information, associated with a user that sent a particular text message, may need to be collected. A user may be prompted for giving permission to collect such additional information before the additional information is collected.

As an example, collected messages may be filtered based on recency. For example, only messages sent within a couple of hours, or within one day, of a present time may be provided for keyword extraction. A user may not be interested in text messages that were sent a long time ago, or even a day ago. As another example, collected messages may be filtered based on language. A user may only want to see keywords in a language the user understands. As yet another example, the collected messages may be filtered based on age. For example, teenagers may only want to see keywords from text messages sent by other teenagers. As a further example, collected messages may be filtered to remove text messages that include profanity, include abusive or threatening language, or include sexually explicit language. A user may be offended by profane, abusive, or sexually explicit language and may not want to see keywords from such text messages.

In one implementation, one or more of a set of filtering criteria may be applied for a particular group of users. For example, filtering based on the same location may be performed for all users that are to receive keywords in a particular geographic area. Thus, for example, all users associated with the same cellular ID may be provided with keywords extracted based on the same set of filtered text messages. In another implementation, one or more of a set of filtering criteria may be applied for a particular user. For example, filtering based on the same location may be performed independently for particular users. Thus, a particular user may be provided with keywords extracted from text messages based on a set of filtered messages associated with the particular user.

In order to protect the privacy of senders of text messages, the filtered set of messages may need to include text messages from at least a particular number of distinct users. If the number of distinct users, from which the filtered text messages were obtained, becomes smaller than a particular number, the privacy of the users may become compromised. For example, if keywords or key phrases are extracted from text messages originating from a single user, the privacy of that user may be breached. Therefore, if text messages are not available from at least a particular number of distinct users, either no text messages may be provided, or the filtering criteria may be broadened. For example, the geographic area may be increased.

Keywords or key phrases may be extracted from the filtered messages (block 630). For example, keyword extractor 530 may apply one or more keyword extraction algorithms to a set of filtered messages. Keyword extractor 530 may apply any existing keyword extraction algorithm. For example, keyword extractor 530 may identify keywords based on TF*IDF, where TF represents the frequency of a keyword in a text message and IDF represents the frequency on the keyword in a collection of text messages, such as the collection of text messages stored in text messages database 505. As another example, keyword extractor 530 may use a lexicon of keywords to recognize keywords in text messages. Keyword extractor 530 may use a lexicon that includes terms, such as abbreviations and/or jargon, commonly used in text messages. Keyword extractor 530 may consult a list of stop words and may not consider any stop words as keywords. Stop words may include commonly used words or abbreviations that may not include any semantic information relating to the subject of text messages, such as pronouns, articles, or auxiliary verbs. Keyword extractor 530 may also exclude first person names from consideration as keywords.

Additionally, keywords may be corrected for minor spelling errors. For example, the terms “judgement” and “judgment” may both be extracted as the keyword “judgment.” Furthermore, stemming processing may be applied to keywords. For example, the terms “rain” and “raining” may both be extracted as the keyword “rain.” Key phrases, which may include more than one key word, may also be identified. Key phrases may be identified based on being included in a lexicon or based on appearing a particular number of times (e.g., based on a TF*IDF score). Key phrases may be limited to a particular number of words, such as three word phrases.

The extracted keywords or key phrases may be ranked (block 640). For example, keyword ranker 540 may rank the extracted keywords based on one or more criteria. In one implementation, the keywords may be ranked based on frequency. Thus, keywords that appear more frequently may be ranked higher than keywords that appear less frequently, for a particular time period. In other implementations, keywords may be ranked based on different or additional criteria.

For example, keyword ranker 540 may rank key phrases based on a combination of frequency and inverse keyword frequency. Inverse keyword frequency may refer to how frequently a keyword appears in a collection of keywords and key phrases, such as text messages stored in keyword database 505. Keywords or key phrases with a higher inverse keyword frequency may appear less frequently in text messages and may therefore carry more information when such keywords or key phrases do appear in text messages.

As another example, keyword ranker 540 may rank keywords or key phrases based on a number of terms. A key phrase that includes more than one term may carry more information and may, therefore, be determined to be more important.

A keyword or a key phrase may be ranked based on augmenting criteria associated with particular instances of the keyword or key phrase (i.e., criteria associated with particular text messages from which the keyword or key phrase was extracted). If a particular instance of the keyword or key phrase is associated with an augmenting criterion, the rank of the keyword or key phrase may be increased. For example, keywords may be ranked based on geographic proximity. If many text messages from a particular location include the same keyword or key phrase, it may indicate that something important has happened at that location and may be of more interest to users. For instance, if a particular number of text messages associated with a particular intersection include the keyword “accident,” the keyword may be ranked higher than if the same number of text messages include the keyword but are associated with different locations.

As another example, keywords may be ranked based on a number of recipients. User may have the option to send a text message to more than one recipient. A text message sent to multiple recipients may be determined to be more important than a text message sent to a single recipient. Thus, if a keyword or key phrase was extracted from a text message sent to multiple recipients, the keyword or key phrase may receive a boost in a rank score.

In one implementation, keywords or key phrases may be ranked without the ranking being associated with a particular user. In such an implementation, different users may receive the same set of ranked keywords or key phrases. In another implementation, keywords or key phrases provided to a particular user may additionally be ranked based on one or more criteria associated with the user.

For example, keywords or key phrases may be ranked based on a user's preferences. A user may indicate one or more interests in a user profile associated with the user, and keyword extractor 530 may tag keywords or key phrases with a topic. For example, a particular user may be interested in sports, and keywords or key phrases that are tagged with a sports topic may be ranked higher when being provided to the particular user. As another example, keywords or phrase may be ranked based on a sender of the user. For example, a sender of a text message may give permission to text messaging hot topics system 120 to identify the sender with the text message. Alternately, a sender of text message may give permission to text messaging hot topics system 120 to identify the sender with the text message with respect to other particular users (e.g., users that know the sender). A particular user may want to see keywords from text messages sent by other users that the particular user personally knows, and keywords from users known by the particular user may be ranked higher when provided to the particular user.

A keyword or key phrase may be assigned a rank score with respect to each ranking factor, and the rank scores may be combined into a final rank score for the keyword or key phrase. For example, each ranking factor may be assigned a weight and the final rank score may be based on a weighted sum of the rank scores associated with the individual ranking factors.

In one implementation, keywords or key phrase may be ranked based on more than one ranking scale. For example, keyword ranker 540 may rank keywords or key phrases based on frequency, may rank keywords or key phrases based on topics, and may rank keywords or key phrases based on senders of text messages associated with keywords or key phrases. In such an implementation, when the ranked keywords or key phrases are provided to a user, the different ranking scales may be associated with different indications. For example, keywords or key phrases with higher frequencies may appear in larger font, keywords or key phrases associated with a particular user's interests may appear in bold, and keywords or key phrases associated with senders that the particular user knows may include a border around the keyword.

The ranked keywords or key phrases may be provided to a user (block 650). For example, user interface 550 may transmit a list or ranked keywords or key phrases to user device 110. In one implementation, a hot topics application that has been installed on user device 110 may receive the transmitted keywords or key phrases and may display the ranked keywords or key phrases on display device 210. In another implementation, a user interface may be provided by text messaging hot topics system 120 to user device 110, without user device 110 having to install a hot topics application. The provided ranked keywords or key phrases may be dynamically updated at configurable intervals.

A request for additional information may be received (block 660) and additional information may be provided (block 670). A user may be able to request additional information in association with a received keyword or key phrase. For example, a user may select a displayed keyword or key phrase and may be presented with one or more options for additional information.

As an example, a user may be able to select to see messages from which a keyword was extracted. Senders of messages may give permission that their text messages may be shown to other users. For example, a user may see something interesting and text a friend about it, and may also indicate that other users may view the message. Additionally or alternatively, a user may be able to select which users (e.g., other users that the user may know) sent a particular keyword or key phrase.

As another example, a user may be able to see other keywords or key phrases that appeared with the selected keyword or key phrase in a text message. Keyword extractor 530 may store information associating keyword or key phrases that appear together in text messages a particular number of times. Thus, a user may see the keyword “accident,” select to see other keywords, and may see the key phrase “fifth avenue,” which may provide information about the location of an accident.

As yet another example, a user may select to perform a local search using a selected keyword or key phrase. When a user select to perform a local search, the selected keyword or key phrase may be submitted to a search engine and search results may be provided to the user.

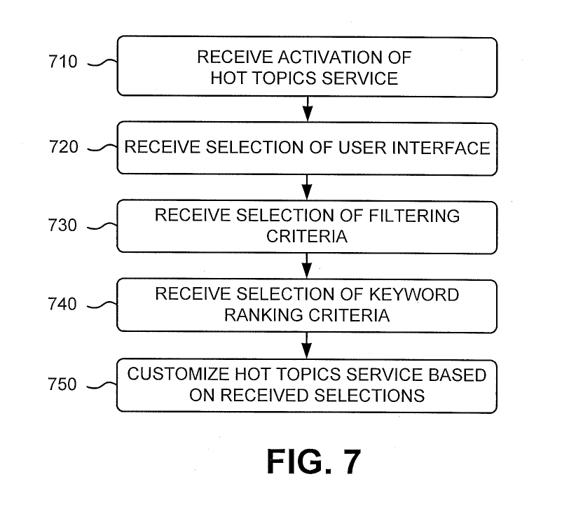

FIG. 7 is a flow graph of an exemplary process of receiving selections from a user according to an implementation described herein. In one implementation, the process of FIG. 7 may be performed by text messaging hot topics system 120. In other implementations, the process of FIG. 7 may be performed by a different device or a group of devices. For example, the process of FIG. 7 may be performed by user device 110.

The process of FIG. 7 may include receiving activation of a hot topics service (block 710). For example, text messaging hot topics system 120 may receive, from user device 110, a request for text messaging hot topics service. In one implementation, a user may access a particular web site associated with text messaging hot topics system 120 and download a hot topics application onto user device 110. The hot topics application may implement a user interface on user device 110 for displaying keyword provided by text messaging hot topics system 120 to user device 110. In another implementation, a user interface for displaying keyword may be implemented by text messaging hot topics system 120.

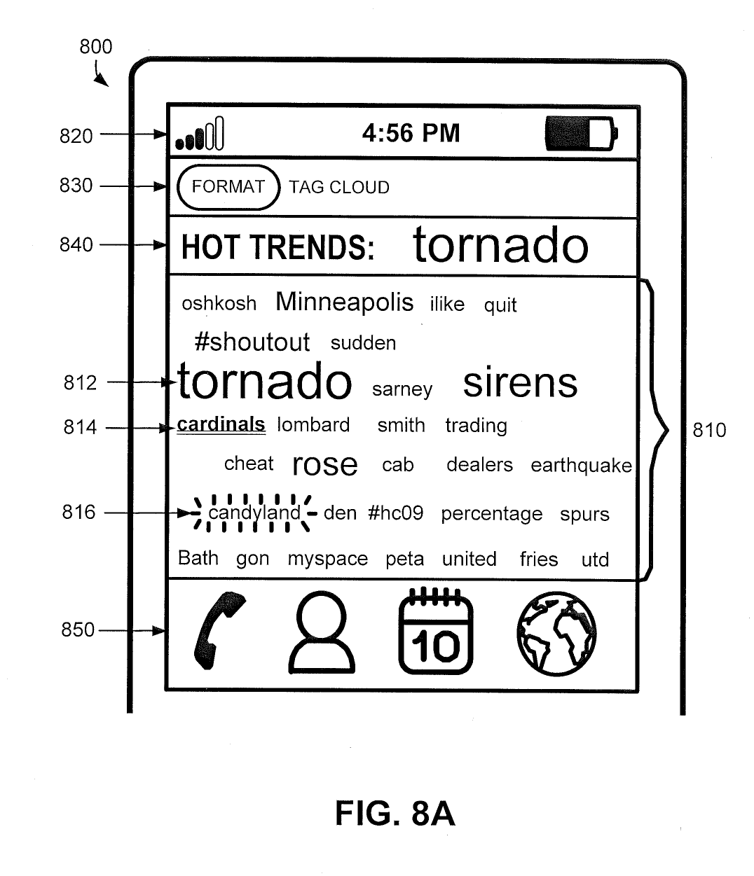

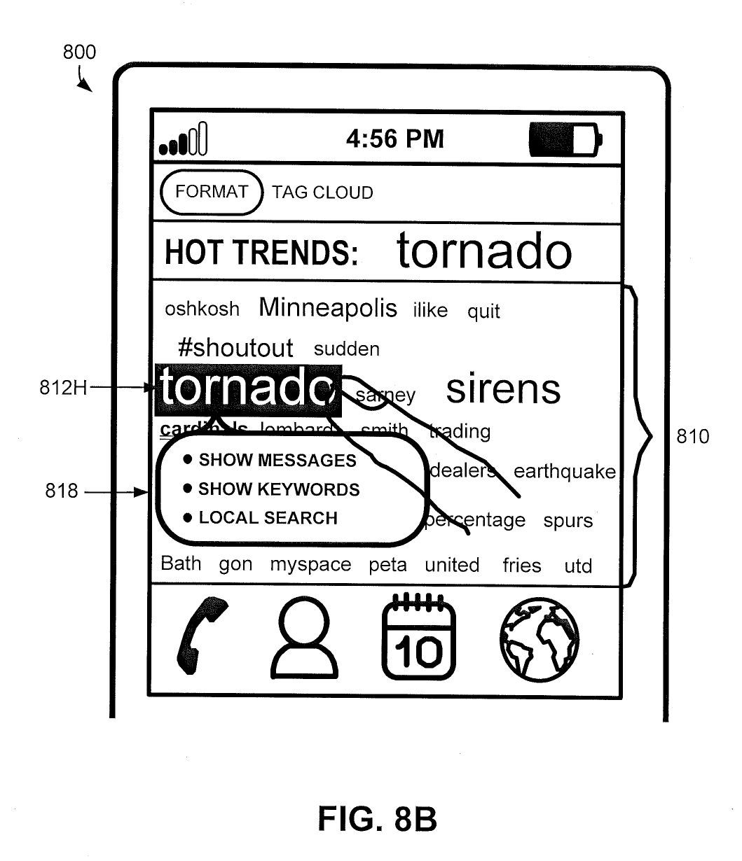

Selection of a user interface may be received (block 720). A user may select a particular user interface for receiving keywords. Exemplary user interfaces that a user may select may include a tag cloud of keywords; a widget, such as a menu item, a toolbar, or a button; an animation, such as a ticker tape of keywords moving across display 210; a three-dimensional object with keywords on the surface of the object; or receiving keywords via text messages. Exemplary user interfaces are discussed below with respect to FIGS. 8A, 8B, 9, 10A, and 10B.

Selection of filtering criteria may be received (block 730). A user may select one or more filtering criteria for filtering text messages. For example, a user may be able to configure the size of the geographic area from which keywords are extracted. For example, some users may want to see keywords from users in a whole city, while other users may want to see keywords from users in a neighborhood of the city. A user may be able to specify a geographic area other than the user's current location. For example, a user may want to see keywords from the user's home town if the user is away on a business trip. As another example, a user may select to see keywords only from a particular age group. As yet another example, a user may select to see keywords from text messages in a particular language.

Selection of ranking criteria may be received (block 740). A user may specify one or more ranking criteria for ranking keywords. For example, a user may specify one or more topics that the user is interested in. As another example, a user may specify a group of users, such as the user's friends and family, and keywords from text messages send by the group of users may be given priority over other keywords.

The hot topics service may be customized based on the received selections (block 750). In one implementation, text messaging hot topics system 120 may save the user's selections in a user profile associated with the user. In another implementation, the user's selections may be stored in user device 110 by a hot topics application that has been installed in user device 110.

FIG. 8A is a diagram illustrating a first exemplary user interface 800 according to an implementation described herein. In one implementation, user interface 800 may be provided, for example, on display 210 of user device 110. In other implementations, user interface 800 may be provided on another device. For example, user interface 800 may be provided on a display associated with a user's desktop computer. User interface 800 may include a tag cloud 810, indicator icons 820, a format widget 830, a top keyword indication 840, and control button icons 850.

Tag cloud 810 may display keywords received from text messaging hot topics system 120. Tag cloud 810 may be updated with new keywords or key phrases based on a particular time period. The time period may be configurable by the user. In one implementation, tag cloud 810 may be displayed as an active window on display 210. In another implementation, tag could 810 may be displayed as a wallpaper on display 210, may appear behind other icons or widgets on display 210, and may run in the background.

Tag cloud wallpaper 810 may include a first indication keyword 812, a second indication keyword 814, and a third indication keyword 816. First indication keyword 812 may include an indication of rank based on a first ranking scale. For example, the first ranking scale may be based on frequency of occurrence, and keywords that have appeared more frequently in text messages may appear in larger font. Second indication keyword 814 may include an indication of a rank based on a second ranking scale. For example, the second ranking scale may be based on a user's indicated interests, and keywords which relate to the user's interests may appear in bold font. Third indication keyword 816 may include an indication of a rank based on a third ranking scale. For example, the third ranking scale may be based on other users that are known by the user, and keywords from messages sent by other users that are known by the user may appear with a border around the keyword. While FIG. 8A illustrates indications based on three different ranking scales, indications based on fewer, more, or different ranking scales may be displayed.

Indicator icons 820 may display indications associated with operation of user device 110. For example, indication icons 820 may include a signal strength indicator icon, a current time indicator icon, and a battery life indicator icon.

Format widget 830 may include an indication of a selected format for providing keywords, and may include a way for the user to change the display format of received keywords. In one implementation, format widget 830 may include a button and a user may toggle between different formats by clicking on the button. In another implementation, format widget 830 may include a drop-down menu and a user may select a display format from the drop-down menu.

Top keyword indicator 840 may display a current top keyword. The current top keyword may be the keyword that is ranked the highest among extracted keywords. For example, the current top keyword may include the keyword that appears in the most text messages.

Control button icons 850 may include control buttons for operation of user device 100. For example, control buttons 850 may include a button to activate a phone application, a button to access a contact application, a button to access a calendar application, and a button to access a Web browser.

FIG. 8B is a diagram illustrating another aspect of the first exemplary user interface of FIG. 8B. In one implementation, keywords that appear on tag cloud wallpaper 810 may be selectable. A user may touch one of the keywords and indications of one or more options may be presented to the user. When a user touches one of the keywords on display 810, the keyword may change to highlighted keyword 812H, thus providing an indication to the user that the keyword was selected. A user may be provided with one or more options for additional information relating to the highlighted keyword.

The one or more options may be provided, for example, via a tooltip 818. The one or more options may include the one or more options as selectable items in a list. The options may include, for example, an option to show messages that include highlighted keyword 812H. A user may give permission that a particular message that the user is sending may be viewable by users other than indicated recipients of the message. The one or more options may also include an option to show keywords that are associated with highlighted keyword 812H. For example, a user may not give permission that a particular message that the user is sending may be viewable, but may give permission that other keywords included in the message with highlighted keyword 812H may be displayed. Another option that may be provided may be an option to perform a local search using highlighted keyword 812H. For example, when this option is selected by the user, highlighted keyword 812H may be submitted to a search engine as a search query. The search engine may perform a local search using the search query.

Although FIGS. 8A and 8B show exemplary components of user interface 800, in other implementations, user interface 800 may contain fewer, different, differently arranged, or additional components than depicted in FIGS. 8A and 8B. In still other implementations, one or more components of user interface 800 may perform one or more other tasks described as being performed by one or more other components of user interface 800, or may depict information described as being depicted by one or more other components of user interface 800.

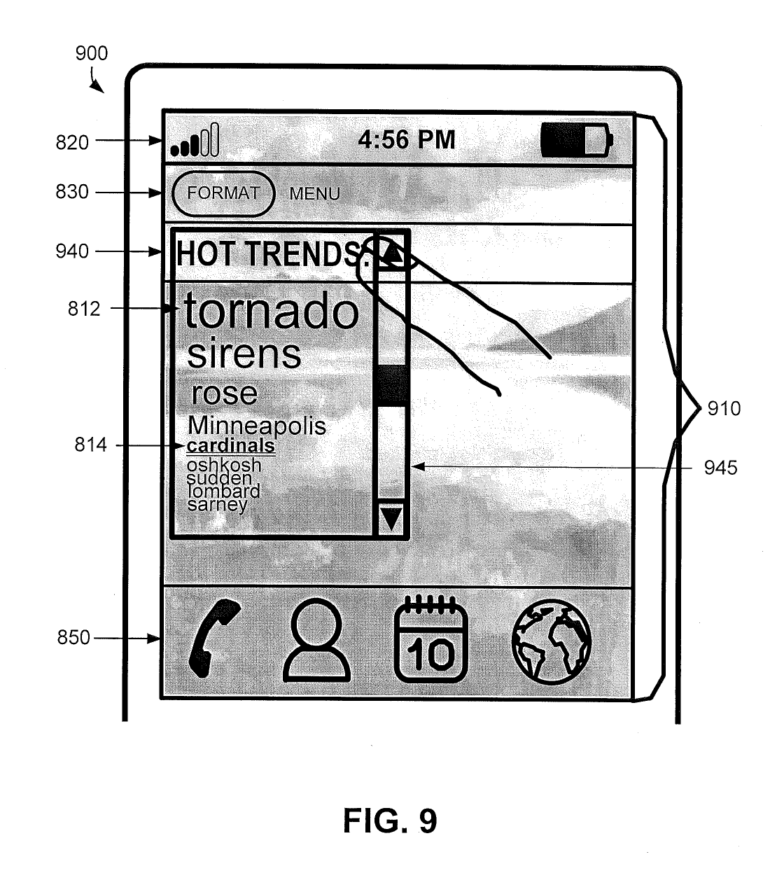

FIG. 9 is a diagram illustrating a second exemplary user interface 900 according to an implementation described herein. In one implementation, user interface 900 may be provided, for example, on display 210 of user device 110. In other implementations, user interface 900 may be provided on another device. For example, user interface 900 may be provided on a display associated with a user's desktop computer. User interface 900 may include may include a background wallpaper 910, indicator icons 820, a format widget 830, a keyword menu 940, and control button icons 850.

Background wallpaper 910 may include an image that a user selected to use as a wallpaper. Indicator icons 820, format widget 830, and control button icons 850 may correspond to indicator icons 820, format widget 830, and control button icons 850 described with respect to FIG. 8A.

Keyword menu 940 may display keywords as a list of menu items. A user may expand menu 940 by touching or clicking on keyword menu 940 using a finger or a stylus. A user may also be able to expand menu 940 by pressing a particular key or a combination of keys on control key 250 or on keypad 260. Keyword menu 940 may include a scroll bar 945 for scrolling through the displayed keywords. Keyword menu 940 may display keywords based on a first ranking scale, such as based on the frequency of occurrence of the keywords. Additionally, keyword menu 940 may include first indication 812 and second indication 814. For example, keywords that appear more frequently may be displayed with larger font, and keywords that relate to a user's interests may appear in bold.

Although FIG. 9 shows exemplary components of user interface 900, in other implementations, user interface 900 may contain fewer, different, differently arranged, or additional components than depicted in FIG. 9. In still other implementations, one or more components of user interface 900 may perform one or more other tasks described as being performed by one or more other components of user interface 900, or may depict information described as being depicted by one or more other components of user interface 900.

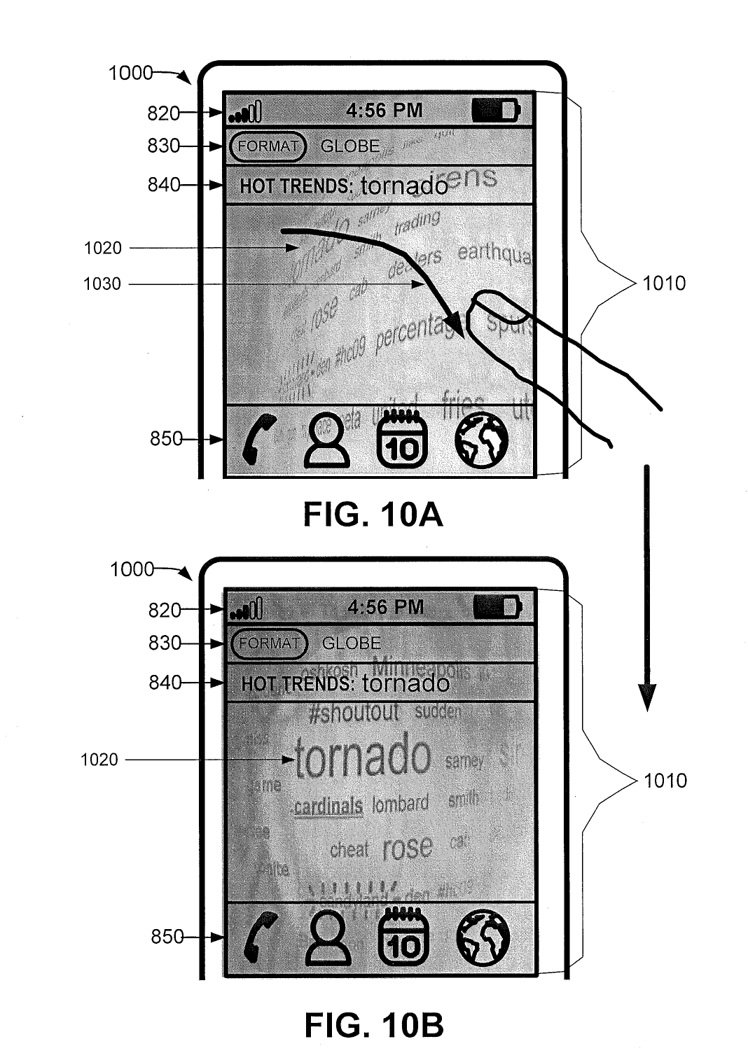

FIG. 10A is a diagram illustrating a third exemplary user interface 1000 according to an implementation described herein. In one implementation, user interface 1000 may be provided, for example, on display 210 of user device 110. In other implementations, user interface 1000 may be provided on another device. For example, user interface 1000 may be provided on a display associated with a user's desktop computer. User interface 1000 may include may include a keyword globe 1010, indicator icons 820, format widget 830, top keyword indication 840, and control button icons 850.

Indicator icons 820, format widget 830, top keyword indication 840, and control button icons 850 may correspond to indicator icons 820, format widget 830, top keyword indication 840, and control button icons 850 described with respect to FIG. 8A.

Keyword globe 1010 may display keywords or key phrases on a three-dimensional globe. In one implementation, keyword globe 1010 may be displayed as an active window on display 210. In another implementation, keyword globe 1010 may be displayed as a wallpaper on display 210, may appear behind other icons or widgets on display 210, and may run in the background. A user may be able to manipulate keyword globe 1010 to bring different keywords to the center of user interface 1000. For example, a user may make a finger movement 1030 to bring the keyword “tornado” 1020 to the center of user interface 1000. FIG. 10B illustrates user interface 1000 after the user has performed movement 1030 on user interface 1000. Additionally or alternatively, if user device 110 includes one or more tilt sensors, a user may be able to move keyword globe 1010 by tilting user device 110 in different directions.

While user interface 1000 includes keyword globe 1010, any shape may be used with user interface 1000. For example, keywords may appear on faces of a movable cube. Using a movable shape to display keywords may allow more keywords than would otherwise fit on a screen to be presented to a user. Using a movable shape may also have entertaining value for the user.

Although FIGS. 10A and 10B show exemplary components of user interface 1000, in other implementations, user interface 1000 may contain fewer, different, differently arranged, or additional components than depicted in FIGS. 10A and 10B. In still other implementations, one or more components of user interface 1000 may perform one or more other tasks described as being performed by one or more other components of user interface 1000, or may depict information described as being depicted by one or more other components of user interface 1000.

The foregoing description provides illustration and description, but is not intended to be exhaustive or to limit the description to the precise form disclosed. Modifications and variations are possible in light of the above teachings or may be acquired from practice of the invention.

For example, while series of blocks have been described with respect to FIGS. 6 and 7, the order of the blocks may be modified in other implementations. Further, non-dependent blocks may be performed in parallel.

Furthermore, it is to be understood that other user interfaces within the scope of the systems and methods described herein may be provided. Any input interface that provides keywords to a user may be implemented. For example, the keywords need not be provided via display 210, but may be provided via audio, using speaker 230.

Still further, aspects have been mainly described in the context of a mobile communication device. As discussed above, the device and methods described herein may be used with any type of device that includes an output device. It should also be understood that particular devices discussed above are exemplary only and other devices may be used in alternative implementations to generate the desired information.

It will be apparent that aspects, as described above, may be implemented in many different forms of software, firmware, and hardware in the implementations illustrated in the figures. The actual software code or specialized control hardware used to implement these aspects should not be construed as limiting. Thus, the operation and behavior of the aspects were described without reference to the specific software code—it being understood that software and control hardware could be designed to implement the aspects based on the description herein.

It should be emphasized that the term “comprises/comprising” when used in this specification is taken to specify the presence of stated features, integers, steps, or components, but does not preclude the presence or addition of one or more other features, integers, steps, components, or groups thereof.

Even though particular combinations of features are recited in the claims and/or disclosed in the specification, these combinations are not intended to limit the description. In fact, many of these features may be combined in ways not specifically recited in the claims and/or disclosed in the specification.

No element, act, or instruction used in the description of the present application should be construed as critical or essential to the description unless explicitly described as such. Also, as used herein, the article “a” is intended to include one or more items. Where only one item is intended, the term “one” or similar language is used. Further, the phrase “based on,” as used herein is intended to mean “based, at least in part, on” unless explicitly stated otherwise.

What is claimed is:

1. A device, comprising:
a memory to store instructions; and
a processor to execute the instructions to implement:
a data collector to collect text messages;
a keyword extractor to extract keywords or key phrases from the collected text messages; and
a user interface to present one or more of the extracted keywords or key phrases to a particular user.

2. The device of claim 1, where the data collector collects text messages from call detail records or from user devices.

3. The device of claim 1, further comprising:
a filter to filter the collected text messages based on one or more criteria.

4. The device of claim 3, where the one or more criteria include:
a location associated with a particular text message,
a time and date when the particular text message was sent,
a language associated with the particular text message,
an age of a sender of the particular text message, or
whether the particular text message includes profanity, abusive language, or sexually explicit language.

5. The device of claim 1, where the keyword extractor is to at least one of:
recognize terms particular to text messages;
eliminate stop words from consideration as a keyword or a key phrase;
correct for spelling errors in the extracted keywords or key phrases; or
perform stemming on the extracted keywords or key phrases.

6. The device of claim 1, further comprising:
a keyword ranker to rank the extracted keywords or key phrases based on one or more criteria.

7. The device of claim 6, where the one or more criteria include:
a frequency associated with a particular keyword or key phrase;
a geographic proximity of instances of the particular keyword or key phrase;
a number of recipients associated instances of the particular keyword or key phrase; or
the particular user's preferences.

8. The device of claim 6, where the keyword ranker is to rank the extracted keyword or key phrases based on at least two different ranking scales.

9. The device of claim 1, where the user interface includes:
a tag cloud of the presented keywords or key phrases;
a menu list of the presented keywords or key phrases; or
a movable sphere with the presented keywords or key phrases printed on a surface of the sphere.

10. The device of claim 1, where the user interface includes an option to receive a request, associated with a particular one of the presented keywords or key phrases, for additional information, and where the user interface is to provide the additional information in response to receiving the request.

11. The device of claim 10, where the request includes at least one of:
a request to view text messages associated with the particular one of the presented keywords or key phrases;
a request to view other keywords associated with the particular one of the presented keywords or key phrases; or
a request to perform a search based on the particular one of the presented keywords or key phrases.

12. A method performed by a server device, the method comprising:
collecting, using a processor associated with the server device, text messages sent within a particular geographic area within a particular time period;
extracting, using a processor associated with the server device, keywords or key phrases from the collected text messages; and
providing, using a communication interface associated with the server device, one or more of the extracted keywords or key phrases to a particular user.

13. The method of claim 12, further comprising:
filtering the collected text messages based on one or more criteria.

14. The method of claim 13, where the one or more criteria include:
a location associated with a particular text message,
a time and date when the particular text message was sent,
a language associated with the particular text message,
an age of a sender of the particular text message, or
whether the particular text message includes profanity, abusive language, or sexually explicit language.

15. The method of claim 12, where the extracting keywords or key phrases comprises:
recognizing terms particular to text messages;
eliminating stop words from consideration as a keyword or a key phrase;
correcting for spelling errors in the extracted keywords or key phrases; or
performing stemming on the extracted keywords or key phrases.

16. The method of claim 12, further comprising:
ranking the extracted keywords or key phrases based on one or more criteria.

17. The method of claim 16, where the one or more criteria include:
a frequency associated with a particular keyword or key phrase;
a geographic proximity of instances of the particular keyword or key phrase;
a number of recipients associated instances of the particular keyword or key phrase; or
the particular user's preferences.

18. The method of claim 12, where the providing the one or more of the extracted keywords or key phrases comprises providing the one or more of the extracted keywords of key phrases in one of:
a tag cloud of the one or more extracted keywords or key phrases;
a menu list of the one or more extracted keywords or key phrases; or
a movable sphere with the one or more extracted keywords or key phrases printed on a surface of the sphere.

19. The method of claim 12, further comprising:
receiving a request for additional information associated with one of the one or more provided keywords or key phrases, and
providing the additional information in response to receiving the request.

20. One or more memory devices storing instructions executable by one or more processors, the one or more memory devices including:
one or more instructions to collect text messages sent within a particular geographic area within a particular time period;
one or more instructions to filter the collected text messages based on one or more criteria associated with the collected text messages;
one or more instructions to extract keywords or key phrases from the filtered collection of text messages;
one or more instructions to rank the extracted keywords or key phrases based on frequency of occurrence; and
one or more instructions to provide one or more of the extracted keywords or key phrases to a particular user in a user interface.
